(19) United States
(12) Patent Application Publication
(10) Pub. No.: US 2002/0145780 A1
(43) Pub. Date: Oct. 10, 2002

(54) Simultaneous delivery of 1280 video channels over a WDM passive optical network

(76) Inventors: Nicholas J. Frigo, Redbank, NJ (US); Patrick P. Iannone, Redbank, NJ (US); Kenneth C. Reichmann, Hamilton, NJ (US)

Correspondence Address: BANNER & WITCOFF LTD.,, ATTORNEYS FOR AT & T CORP, 1001 G STREET , N.W., ELEVENTH STREET, WASHINGTON, DC, 20001-4597, US

(21) Appl. No.: 09/946,177

(22) Filed: Sep. 5, 2001

Related U.S. Application Data
(60) Provisional application No. 60/229,541, filed on Sep. 5, 2000.

(51) Int. Cl. H04J 14/02; H04B 10/00

(52) U.S. Cl. 359/125; 359/168

(57) ABSTRACT

Simultaneous delivery of 1280 video channels over a passive optical network using wavelength division multiplexing (WDM). The network is suitable for carrying broadcast and switched services. Its high capacity is achieved by stacking four RF blocks on fours spectrally sliced WDM PON bands in a manner which reduces spontaneous beat noise.

### Relation To Prior Application

This application claims priority to Provisional Patent Application No. 60/229,541 filed Sep. 5, 2000 and entitled “Simultaneous Delivery Of 1280 Video Channels Over A WDM Passive Optical Network” which is herein incorporated by reference.

### BACKGROUND OF THE INVENTION

The present invention generally relates to the field of telecommunication services and more particularly, is directed to a method and apparatus for the simultaneous delivery of 1280 video channels over a passive optical network using wavelength division multiplexing (WDM)

As known in the prior art, telecommunications services generally fall into two major categories. There are the so-called broadcast services in which all users receive the same information and the so-called switched services in which each user receives information specific to the specific user. Generally, network infrastructures can also be classified in the same way. An example of a broadcast infrastructure is the classical CATV networks and an example of a switched infrastructure is the public switched telephone network (PSTN). It usually is more economical to deliver broadcast services over broadcast network and switched services over switched networks.

Recent work has shown that the optical properties of certain passive devices can be exploited to permit a given infrastructure to emulate both broadcast and switched. See, for example, U.S. Pat. No. 5,742,414 entitled “Multiplicity of Services Via a Wavelength Division Router” which issued on Apr. 21, 1998. This patent teaches that the cyclical properties of a waveguide grating router (WGR) can be used in conjunction with wavelength division multiplexing (WDM) on several scales of granularity to provide flexible partitioning of both types of networks (broadcast and switched) using the same physical infrastructure. In particular, it is disclosed that by using the cyclical or periodic properties of the WGR (sometimes also called “Arrayed Waveguide Grating” (AWG), “Phased Array” (Phasar), or the “Dragone Router”), together with an optical source having a wide spectral emission favors broadcast delivery, while “line sources” with narrow spectra favors switched service delivery. The use of a wide optical spectrum floods the output optical channels so that each output port carries a replica, or spectral slice, of the signal on the input port. The linear properties of this passive device makes it possible to overlay both broadcast and switched services simultaneously on the same infrastructure.

Recent work has also demonstrated the use of passive optical network (PON) architectures based on using a WGR as the distribution element at the remote node. The WGR permits simultaneous and cost-effective transmission of both broadcast and switched services with tremendous flexibility. Wavelength-specific lasers are used for high-speed point-to-pint switched connections, while broadcasting uses broadband sources, (LEDs or ASE sources) which illuminate all output ports of the WGR at once. Optical bandpass filters spanning a free spectral range (FSR) of the wavelength cyclic WGRs define cascadable service bands.

While the above described use of passive optical network (PON) architectures based on using a WGR as the distribution element at the remote node afforded much more efficient and cost-effective transmission of broadcast and switches services than know prior, Applicants have discovered that additional efficiencies and more cost-effective transmissions are possible.

### SUMMARY OF THE INVENTION

Accordingly, it is an overall object of the present invention is to provide an improved network for telecommunication services.

Another object of the present invention is to provide an improved network for telecommunication services which can be easily and inexpensively implemented.

A still further object of the present invention is to provide an improved telecommunications network using optical technology.

It is a specific object of the present invention to provide an improved telecommunications network using a passive optical network architecture.

It is another specific object of the present invention to provide an improved telecommunications network using a WGR as the distribution element at the remote node.

It is another specific object of the present invention to provide an improved telecommunications network using a passive optical network architecture and a WGR as the distribution element at the remote node.

These and other objectives of the present invention are achieved by the present invention as described below.

In accordance with the present invention, the capacity of a WDM passive optical network using a WGA as the distribution element at the remote note is increased by four fold. This increase ids accomplished increasing the number of RF block for a wavelength band. The number of RF subcarriers, however, drives the spectrally sliced channels at the receiver into a spontaneous-spontaneous (sp-sp) beat noise limited regime. A novel method using multiple WGR input ports to expand the effective optical bandwidth of the received signal achieve of the extremely high capacity made possible by the present invention. In accordance with the present invention, simultaneous operation of the entire service matrix of the wavelength and RF bands containing 1280 video channels is realized.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 is illustrates the present invention using WDM and RF carrier stacking;

FIG. 2 is a graph showing receiver sensitivity for RF subcarriers in optical band 2;

FIGS. 3 is a graph showing receiver sensitivity for subcarriers 1 and 16 in various optical bands and RF blocks; and

FIG. 4 is a graph showing power penalty due to sp-sp beat noise.

### DESCRIPTION OF THE PREFERRED EMBODIMENT

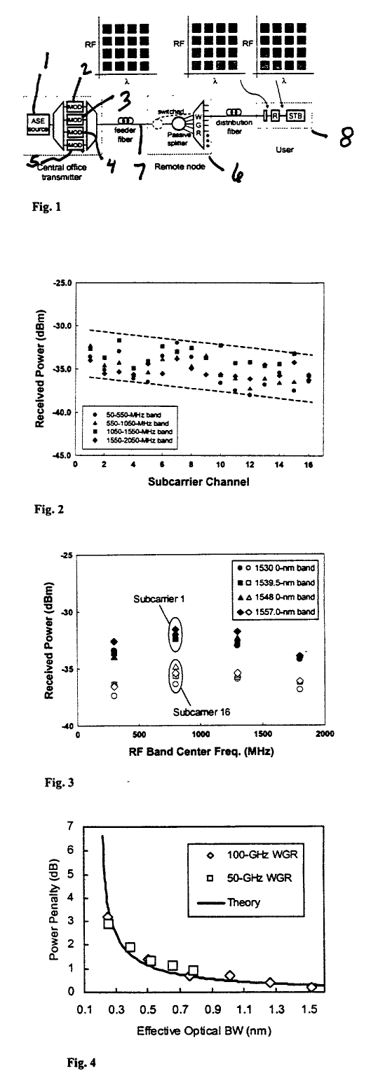

FIG. 1 is a diagram of the present invention. The outputs of a broadband ASE source 1, a gain-flattened Erbium-doped fiber amplifier (EDFA), is sliced into 4 optical bands 2-5 whose width matches the FSR of the distribution WGR at a Remote Node 6. Each spectral band is modulated with 4 blocks of RF that are derived from a commercial satellite antenna. Each RF blocks of 500 MHZ contains >80 digital video channels multiplexed into 16 QPSK carriers in the 950-1450 MHz band. After block -conversion into blocks between 50-550, 550-1050, 1050-1550, and 1550-2050 MHz., these RF bands are combined to externally modulate each of the four optical bands. Consequently, the re-multiplexed optical signal in the feeder fiber 7 shown in FIG. 1 contains the entire service matrix shown in FIG. 1. Each square box represents a 500 MHz block of the commercial service.

In principle, this service suite can be delivered to a WGR at a Remote Node where it can be spectrally sliced and delivered to subscribes, along with switched traffic. However, here we are concerned only with the broadcast services. An optical filter at the subscriber site, nominally matched to one of the transmitter WDM bands, selects a “column” (stack of RF blocks). The optical signal is detected with an APD, the resulting RF stack is block-converted and bandpass filtered to send the desired RF block to the set-top box 8. A problem with this scheme is that the spectral slice, the optical portion of the column sent to the detector from it corresponding WGR output port, has a narrow optical width (i.e., the WGR channel width). Adding RF blocks reduces (because of clipping limitations) the modulation depth of each RF carrier, making the system susceptible to spontaneous-spontaneous beat noise Nₛₚ₋ₛₚ. This impairment can be reduced by passively splitting the broadcast signal and introducing it to the WGR on several input ports. This multiples the effective optical bandwidth by the number of connected ports and decrease the optical power only by the splitter excess loss, not its splitting ratio. This feature, and the suppression of Mach-Zedner interferometric nose, accrues by virtue of routing and cyclical properties of the WGR.

An implementation of this system used passive splitter and bulk thin-film filters to emulate the transmitter's WDMs and a single 2.5 Gb/s LiNbO₃ modulator to simultaneously modulate the entire spectrum after the EDFA noise source. The noise reduction scheme was tested by connecting from one to six of the ports form a 1×8 power splitter to either and 8×8 WGR with 100 GHz spacing or a 16×16 WGR with 50 GHz spacing at Remote Node 6.

Since the point of a WDM PON is the ability to upgrade to switches services, the dashed line in the Remote Node 6 shows how those switched services would be split off with a coarse WDM before being introduced to the WGR.

In verifying the above described system of the invention, satellite TV broadcast signals from a DSS service were applied to the system so that the RF blocks represented realistic existing service loads. The receiver input was optically attenuated until the video was corrupted enough to create “blockiness” on the video or chirp on the audio channel. Thus, the receiver sensitivity for any channel in any RF block in the service matrix could be measured.

FIG. 2 shows measured receiver sensitivities for each RF carrier in optical “column 2,” a stack of RF blocks. In this configuration, 6 of the WGR input ports were fed, leaving two for switched services. The results are fairly uniform and decrease along the band, due partly to electronics between the final RF mixer and the set-top box.

FIG. 3 shows consistency in going along the “rows” of blocks. That is, the groups of four symbols are fairly tight. These two figures demonstrate that with improved RF engineering, one can expect sensitivities near −35dBm.

FIG. 4 shows the effect of connecting multiple splitter outputs to the WGR inputs. The carrier to noise ration (CNR) for the signals detected at the APD can easily be calculated for the presence of thermal, shot, and sp-sp beat noise components. Considered in isolation, the CNR due to sp-sp beat noise is given by:

$$Equation 1 : {CNR}_{sp - sp} \approx \frac{{m}^{2} κ {B}_{o}}{{NF}_{APD} ( 1 + p ) {B}_{e}}$$

Where m is the modulation index for the QPSK subcarriers, k is the number of WGR input ports connected to the splitter, B₀ is the optical bandwidth of a single WGR channel, NFAPD is the noise factor due to the APD avalanche, 0≦p≦| is the degree of polarization and Be is the electrical bandwidth of a subcarrier (30 MHz).

Decreasing m (increased number of RF carriers) and B₀ (spectral slicing) ultimately makes CNRₛₚ₋ₛₚ approach the minimum system CNR. At the point, Equation 1 shows that increasing optical power does not help, but increasing effective optical bandwidth does. After a baseline sensitivity test (with WGR removed to obtain low sp-sp noise) we measured and calculated the penalties associated with connecting multiple ports. Expressed as an equivalent optical bandwidth, the theory is a universal curve. As can be seen, there is excellent agreement between the theory and experiment for both WGRs (1-6 ports for the 100 GHz WGR and 2-6 ports for the 50 GHz WGR.

It should be obvious from the above-discussed apparatus embodiment that numerous other variations and modifications of the apparatus of this invention are possible, and such will readily occur to those skilled in the art. Accordingly, the scope of this invention is not to be limited to the embodiment disclosed, but is to include any such embodiments as may be encompassed within the scope of the claims appended hereto.

We claim:

1. A method of simultaneous deliver of a plurality of video channels over a WDM passive optical network, said method comprising the steps of:
providing an input signal source;
providing a passive optical network;
providing a wavelength division multiplexing device; and
stacking a plurality of RF block on a plurality of slicked WDM PON bands.
